(19) United States
(12) Patent Application Publication
(10) Pub. No.: US 2022/0381127 A1
(43) Pub. Date: Dec. 1, 2022

(54) SIDETRACK WELL PARAMETER IDENTIFICATION BASED ON SIMULATIONS RELATED TO AN EXISTING PHYSICAL WELL

(71) Applicant: Saudi Arabian Oil Company, Dhahran (SA)

(72) Inventors: Babatope Kayode, Dhahran (SA); Muhammad Sohaib Saeed, Dhahran (SA)

(21) Appl. No.: 17/332,066

(22) Filed: May 27, 2021

(51) Int. Cl. E21B 43/30; E21B 49/08; E21B 47/02; E21B 7/06

(52) U.S. Cl. CPC E21B 43/305; E21B 49/087; E21B 47/02; E21B 7/06; E21B 2200/20

(57) ABSTRACT

Embodiments herein relate to identifying occurrence of a trigger condition related to an existing physical well. Embodiments further relate to simulating, based on identification of the occurrence of the trigger condition, a plurality of computer-simulated ancillary wells in a vicinity of the existing physical well. Embodiments further relate to determining one or more simulated parameters related to respective ones of the plurality of computer-simulated ancillary wells. Embodiments further relate to determining, based on the one or more simulated parameters, a parameter of a sidetrack well that is to be related to the existing physical well. Embodiments further relate to outputting an indication of the parameter of the sidetrack well. Other embodiments may be described or claimed.

### TECHNICAL FIELD

The present disclosure applies to identification of one or more parameters of a sidetrack well based on simulations related to an existing physical well.

### BACKGROUND

A significant portion of field development plans related to the placement of wells may be based on numerical reservoir simulation results. Specifically, a three-dimensional (3D) geological model may be built, and the model may then be history-matched to calibrate it to observed dynamic data related to one or more wells or a geological location. The history-matched model may then be used for future performance prediction using existing wells or wells that are planned to exist in the future. In order to maximize well profitability and recovery while minimizing investment cost, it may be desirable to drill additional wells using an existing well as a starting point. Such wells may be referred to as “sidetrack” wells.

### SUMMARY

The present disclosure describes techniques that may be usable with a numerical simulator to detect wells that have sidetrack potential (e.g., existing physical wells that may be candidates for having an associated sidetrack well). Embodiments may further assist with identifying a parameter of the sidetrack well such as a depth, direction, or grade of the sidetrack well.

In some implementations, a computer-implemented technique includes identifying occurrence of a trigger condition related to an existing physical well. The technique further includes simulating, based on identification of the occurrence of the trigger condition, a plurality of computer-simulated ancillary wells in a vicinity of the existing physical well. The technique further includes determining one or more simulated parameters related to respective ones of the plurality of computer-simulated ancillary wells. The technique further includes determining, based on the one or more simulated parameters, a parameter of a sidetrack well that is to be related to the existing physical well. The technique further includes outputting an indication of the parameter of the sidetrack well.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular implementations to realize one or more of the following advantages. One such advantage is the ability to efficiently identify existing wells with sidetrack potential, as well as identify parameters of the sidetrack well such as direction, depth, grade, etc. of the sidetrack well. Typically, the cost of drilling such a sidetrack well may be approximately 30% the cost of drilling a new well. As such, efficient identification and use of sidetrack wells may be desirable to optimize investment and recovery of a drilled well.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 depicts an example of wells in a reservoir, in accordance with various embodiments.

FIG. 2 depicts a high-level example technique related to the identification of a parameter of a sidetrack well, in accordance with various embodiments.

FIG. 3 depicts an example of an existing physical well and its associated computer-simulated ancillary wells, in accordance with various embodiments.

FIG. 4 depicts an alternative example plot of an existing physical well and its associated computer-simulated ancillary wells, in accordance with various embodiments.

FIG. 5 depicts an example plot of a simulated parameter of the existing physical well and computer-simulated ancillary wells of FIG. 4, in accordance with various embodiments.

FIG. 6 depicts an alternative example plot of an existing physical well and computer-simulated ancillary wells, in accordance with various embodiments.

FIG. 7 depicts another example plot of the existing physical well and computer-simulated ancillary wells of FIG. 6, in accordance with various embodiments.

FIG. 8 depicts an example parameter of the existing physical well and computer-simulated ancillary wells of FIG. 6, in accordance with various embodiments.

FIG. 9 depicts another example parameter of the existing physical well and computer-simulated wells of FIG. 6, in accordance with various embodiments.

FIG. 10 depicts another example parameter of the existing physical well and computer-simulated ancillary wells of FIG. 6, in accordance with various embodiments.

FIG. 11 depicts an example technique related to the identification of a parameter of a sidetrack well, in accordance with various embodiments.

FIG. 12 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for identifying a location for a sidetrack well based on simulations related to an actual well. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

As used herein, the term “existing physical well” may refer to a well that has been previously drilled into a reservoir. Such a well may also be referred to as an “actual” well.

As used herein, the term “computer-simulated ancillary well” may refer to an ancillary well that has been created or defined by a computer-based simulation program. Such a well may also be referred to herein as an “ancillary” well or a “simulated” well.

Generally, numerical reservoir simulators may output simulation results such as water saturation versus depth at different time-steps. However, this output may be limited only to the simulation grid-blocks to which the well is connected. Simulation grid-blocks may refer to two-dimensional (2D) or 3D subdivisions of the simulation area.

To put it another way, a water saturation versus depth result may be output only for the well's defined perforation interval. As used herein, the term “perforation interval” may refer to the section of a wellbore that has been prepared for production by the formation of channels between the wellbore and the reservoir. Such channels may be created by, for example, hydraulic fracturing or some other technique.

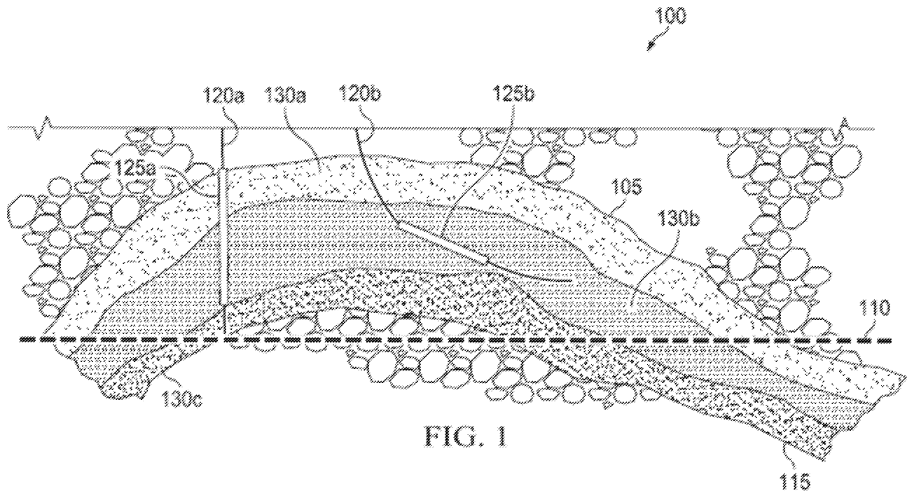

FIG. 1 depicts an example of wells in a reservoir 100, in accordance with various embodiments. Such wells may be, for example, existing physical wells. The reservoir 100 may be defined as shown by a top-of-reservoir line 105 and a bottom-of-reservoir line 115. The reservoir may additionally have a water-oil contact line 110, which indicates a bounding surface in a reservoir 100. Typically, the reservoir 100 may include oil above the water-oil contact line 110, and water below the water-oil contact line 110. The reservoir 100 may further have three subzones 130a, 130b, and 130c, each of which may have different properties such as different permeability, porosity, be formed of different materials, etc.

Two wells 120a and 120b are present in the reservoir 100. As may be seen, well 120a may be drilled generally vertically from the top-of-reservoir 105 to the bottom-of-reservoir 115. The well perforation 125a is only present in subzones 130a and 130b. The second well 120b may only be drilled in subzones 130a and 130b, and only perforated in subzone 130b. The wells 120a/120b may be oil wells, natural gas wells, or some other type of well.

Such a configuration as shown in FIG. 1 may indicate that the subzones 130b and 130c are of relatively poorer quality than subzone 130a, and so the reservoir development strategy may have been to drill dedicated and commingled horizontal wells (e.g., well 120b that is perforated at 125b) in subzones 130b or 130c to take advantage of larger surface area to improve well productivity.

In embodiments, the reservoir of FIG. 1 may be a candidate for the presence of a sidetrack well. Specifically, one or more additional wells may be drilled using either of wells 120a or 120b as a starting point. Such a sidetrack well may be, for example, a horizontal well that is present only in a single subzone (e.g., subzone 130b) of reservoir 100, while in other embodiments the sidetrack well may pass through a plurality of subzones of the reservoir. In some embodiments, the sidetrack well may not be horizontal, but rather may have a grade between, and including, horizontal (e.g., a 0-degree grade) to vertical (e.g., a 90-degree grade). The purpose of the sidetrack well may be to find remaining deposits along an actual watered-out well. As used herein, the term “watered-out” refers to a well where the primary (e.g., greater than or equal to 95 percent) returned product from the well is water.

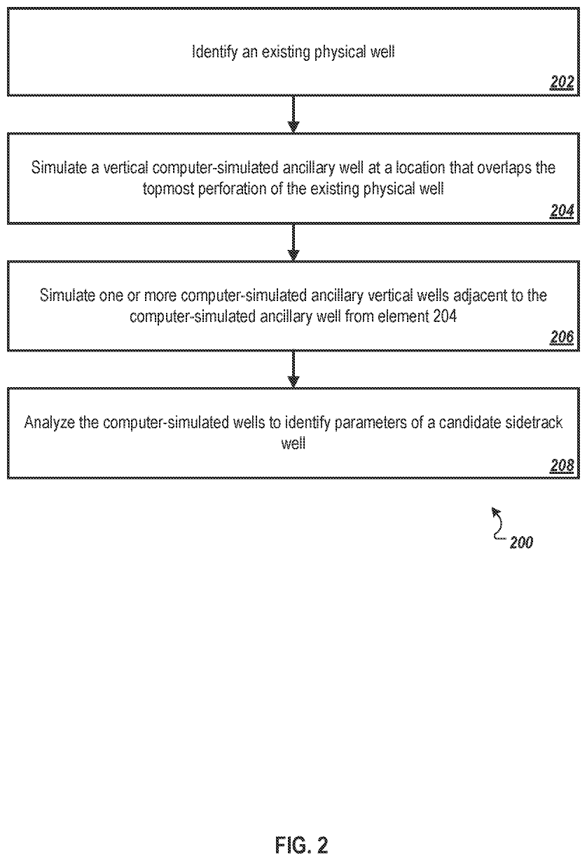

Embodiments herein relate to a technique for identifying one or more existing physical wells that are candidates for an associated sidetrack well, and then identifying a parameter of that sidetrack well such as a location, depth, or direction of the sidetrack well. At a high level, and for the sake of providing context for the description of further embodiments, the technique may include the following elements as depicted in FIG. 2. Specifically, FIG. 2 depicts a high-level example technique 200 related to the identification of a parameter of a sidetrack well, in accordance with various embodiments.

The technique 200 may include identifying, at 202, an existing physical well. The existing physical well may be, for example, a well of a plurality of existing physical wells that are under analysis. In some embodiments, the existing physical well may be identified based on one or more trigger conditions. The trigger condition may be, for example, whether a water-cut of the existing physical well (e.g., the ratio of water to the volume of total liquids produced by the existing physical well) is at or above a pre-determined threshold. For example, if the water-cut of the existing physical well is at or above approximately 95%, which may indicate that the existing physical well is watered-out, then the trigger condition may be satisfied. As another example, the trigger condition may be a gas-oil-ratio (GOR) of the existing physical well. The GOR may refer to a ratio of gas produced by the existing physical well compared to the amount of oil produced by the existing physical well. If the GOR is greater than approximately 1000, then this may indicate that the existing physical well is producing excessive gas, and the trigger condition may be satisfied.

In other embodiments, the trigger condition may be a predicted future satisfaction of the trigger condition. For example, the trigger condition may be based on simulations of production of the existing physical well, which may indicate that the trigger condition will be satisfied at some point in the future.

Satisfaction of the trigger condition may indicate that a sidetrack well may be appropriate, and so further analysis may be performed on the existing physical well. In embodiments where the trigger condition has yet to be satisfied (e.g., is based on a predicted future satisfaction of the trigger condition), then the analysis of the sidetrack well may be for beginning drilling of the sidetrack well in the near future (e.g., upon completion of planning and resource acquisition for the drilling). In other embodiments, the analysis of the sidetrack well may be for planning to drill the sidetrack well upon satisfaction of the trigger condition in the future. For example, if the trigger condition is estimated to be satisfied several years into the future, then the analysis of the sidetrack well may be for the purpose of drilling the sidetrack well in several years upon satisfaction of the trigger condition. It will be understood that the above examples related to the trigger condition may be for the purpose of example, and other embodiments may include alternative trigger conditions, trigger conditions with alternative values, or alternative planning based on the satisfaction of the trigger condition.

The technique 200 may further include simulating, at 204, a computer-simulated ancillary vertical well at a location that overlaps the topmost perforation of the existing physical well. The technique 200 may further include simulating, at 206, one or more additional computer-simulated ancillary vertical wells adjacent to the computer-simulated ancillary well from element 204. In some embodiments, the simulation may include simulation of the formation of the computer-simulated ancillary wells, simulation of production of the computer-simulated ancillary wells, simulation of drilling of the wells, simulation of parameters of the rock at the location of the computer-simulated ancillary wells (e.g., porosity, permeability, or some other value), or some other type of simulation.

For the purpose of discussion herein, the computer-simulated ancillary wells will be described as including four computer-simulated ancillary wells. Respective ones of the computer-simulated ancillary wells may be to the North, South, East, and West of the computer-simulated ancillary well at 204. In some embodiments, the computer-simulated ancillary wells may be a distance away such as a specified number of grid-blocks (e.g., five grid-blocks) from the computer-simulated ancillary well of element 204. However, it will be understood that other embodiments may include more or fewer computer-simulated ancillary wells, computer-simulated ancillary wells in different directions than the cardinal North/South/East/West directions, computer-simulated ancillary wells at non-uniform distances (e.g., one simulated well at a first distance and a second simulated well at a second distance), computer-simulated ancillary wells in the same direction at different distances, or other variations.

The technique 200 may then include analyzing, at 208, the computer-simulated ancillary wells to identify parameters of a candidate sidetrack well. Such parameters may include a depth of the sidetrack well, a direction of the sidetrack well, a grade of the sidetrack well, or some other parameter.

In some embodiments the analysis may include an output of a file that includes parameters of the existing physical well and various ones of the computer-simulated ancillary wells. For example, the existing physical well may be designated as “WELL1184.” The computer-simulated ancillary well from 204 may be designated as “WELV1184.” The North, South, East, and West wells may be designated as “WELN1184,” “WELS1184,” “WELE1184,” and “WELW1184,” respectively. The output file may include further information such as geographic coordinates of the well(s), the depth of the well(s), the location/configuration of perforations of the well(s), a grade of the well(s), etc. In other embodiments, the names or designations of the existing physical and/or computer-simulated ancillary wells may be different.

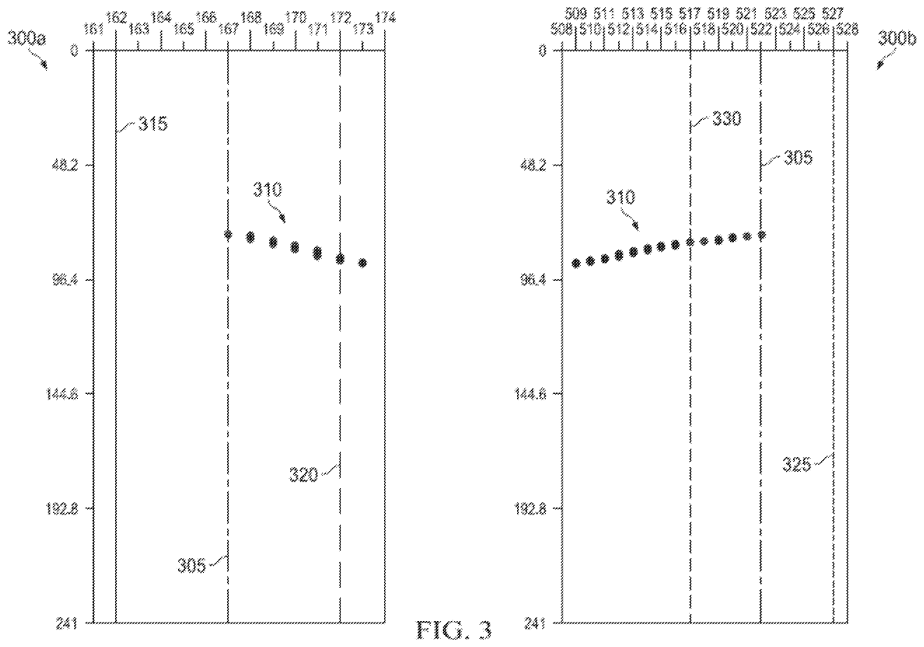

FIG. 3 depicts an example of an existing physical well and its associated computer-simulated ancillary wells, in accordance with various embodiments. Specifically, FIG. 3 depicts two example plots 300a and 300b. Plot 300a depicts the existing physical well and computer-simulated ancillary wells as taken along an East-West cross-section, and plot 300b depicts the existing physical well and computer-simulated ancillary wells as taken along a North-South cross-section. The Y axis of the plots (as oriented in FIG. 3) depict depth of the well(s) (which may be measured in feet, meters, or some other unit) while the X axis of the plots depicts a lateral direction perpendicular to the depth. As shown in FIG. 3, the lateral direction is depicted in units of one unit (or “block”) which may correspond to a predefined distance as measured in feet, meters, or some other unit of distance. For example, in FIG. 3, a block corresponds to approximately 100 meters.

The plots 300a/300b depict a perforated section 310 of an existing physical well, which may be similar to well perforation 125a or 125b. The existing physical well that is the subject of analysis may have been identified based on one or more trigger conditions such as those described above with respect to element 202. The plots 300a/300b further depict a variety of computer-simulated ancillary wells as described above with respect to elements 204 and 206. For example, the plots 300a/300b depict a vertical computer-simulated ancillary well 305 that goes through a topmost portion of the perforated section 310 of the existing physical well. The plots 300a/300b further depict computer-simulated ancillary wells to the North (325), South (330), East (320), and West (315) of computer-simulated ancillary well 305.

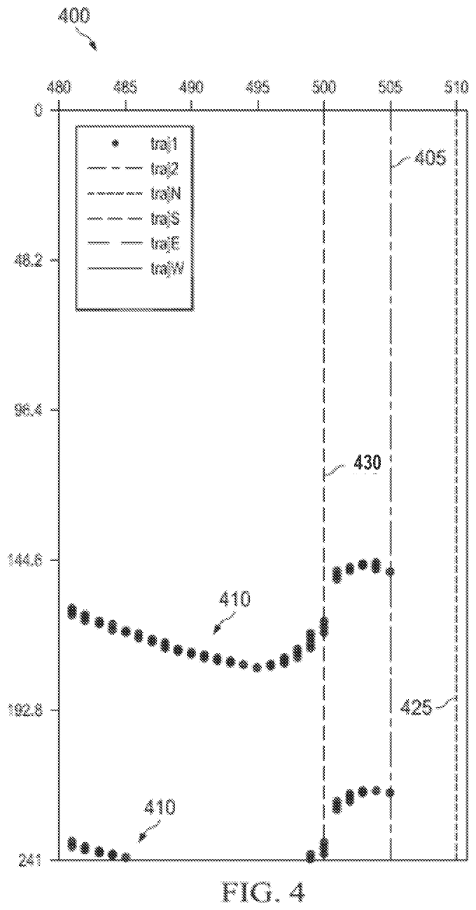

FIG. 4 depicts an alternative example plot 400 of an existing physical well and its associated computer-simulated ancillary wells, in accordance with various embodiments. Specifically, FIG. 4 depicts perforated sections 410, a vertical computer-simulated ancillary well 405, a computer-simulated ancillary North well 425, and a computer-simulated ancillary South well 430, which may be respectively similar to perforated sections 310, vertical computer-simulated ancillary well 305, computer-simulated ancillary North well 325, and computer-simulated ancillary South well 330. It will be noted that, in this embodiment, the blocks are in units of five, rather than units of one as depicted in plots 300a and 300b.

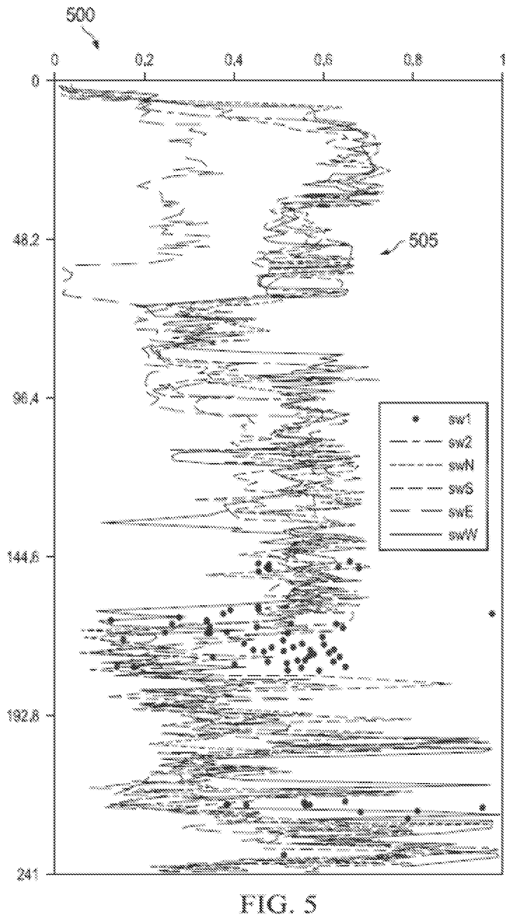

FIG. 5 depicts an example plot 500 of a simulated parameter of the existing physical well and computer-simulated ancillary wells of FIG. 4, in accordance with various embodiments. In this embodiment, the simulated parameter is water saturation (e.g., the amount of water present at the location of the existing physical well or the computer-simulated ancillary well). Water saturation may be selected if, for example, water-cut is used as the trigger condition. Other parameters may be or include permeability (e.g., the permeability of the rock at the location of the existing physical well or computer-simulated ancillary well), porosity (e.g., the porosity of the rock at the location of the existing physical well or computer-simulated ancillary well), gas saturation (e.g., the amount of gas at the location of the existing physical well or computer-simulated ancillary well), or some other parameter.

In the plot 500, the Y axis (as oriented in FIG. 5) represents depth as a k-index of three-dimensional (3D) grid. “K-index” may be a layer index of layers in the model. In the plot 500, the 3D grid has 241 layers. The X axis in plot 500 represents water saturation, with water saturation increasing toward the right of the plot 500 and decreasing toward the left of the plot 500. The plot depicts water saturation of the perforated section 410, the vertical computer-simulated ancillary well 405 (which is labeled in plot 500 as “sw2”), the computer-simulated ancillary North well 425, and the computer-simulated ancillary South well 415. The plot further depicts water saturation of a computer-simulated ancillary West well and a computer-simulated ancillary East well, which may be respectively similar to computer-simulated ancillary West well 315 and a computer-simulated ancillary East well 320.

As may be seen in plot 500, the water saturation profile of the existing physical well and the various computer-simulated ancillary wells are generally in alignment with one another. However, as may be seen further at 505 at around layer 50, the computer-simulated ancillary East well has a significantly lower water saturation, approaching zero. This lower water saturation may indicate that there is untapped oil at a location East of approximately layer 50 of the existing physical well, and so a sidetrack well toward the East at a depth of approximately layer 50 may be desirable.

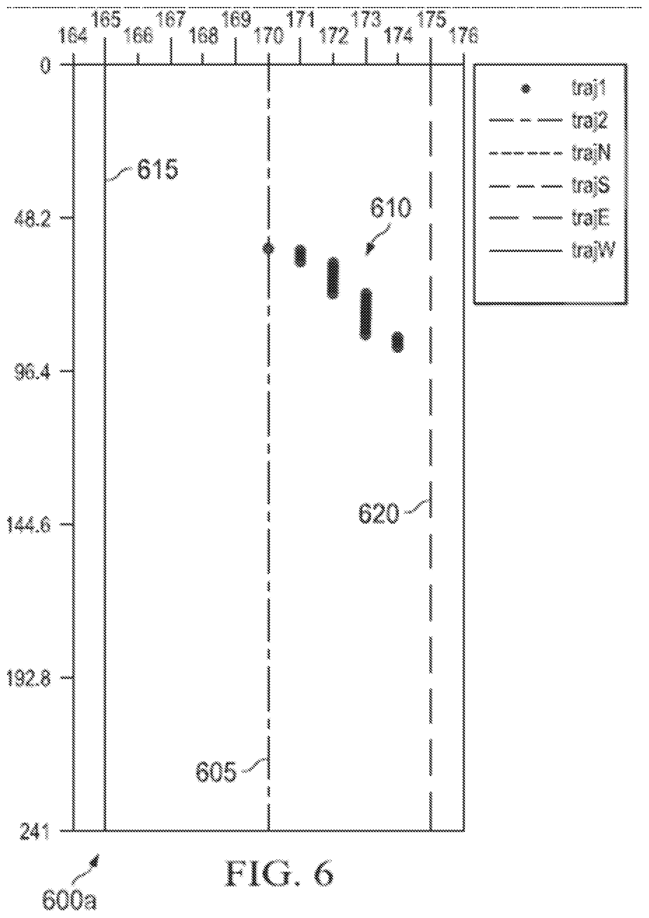

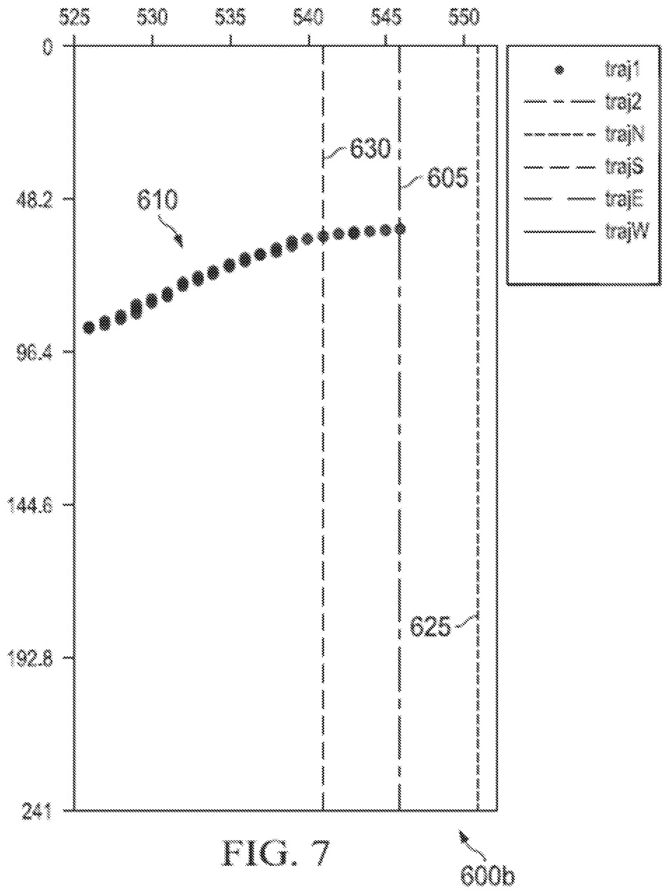

FIG. 6 depicts an alternative example plot 600a of an existing physical well and computer-simulated ancillary wells, in accordance with various embodiments. FIG. 7 depicts another example plot 600b of the existing physical well and computer-simulated ancillary wells of FIG. 6, in accordance with various embodiments. Specifically, the plots 600a and 600b depict a perforated section 610 of an existing physical well, a computer-simulated ancillary well 605, a computer-simulated ancillary West well 615, a computer-simulated ancillary East well 620, a computer-simulated ancillary North well 625, and a computer-simulated ancillary South well 630, which may be respectively similar to perforated section 310, computer-simulated ancillary well 305, computer-simulated ancillary West well 315, computer-simulated ancillary East well 320, computer-simulated ancillary North well 325, and computer-simulated ancillary South well 330. As may be seen in FIGS. 5 and 6, the plots 600a and 600b are depicted in increments of one block.

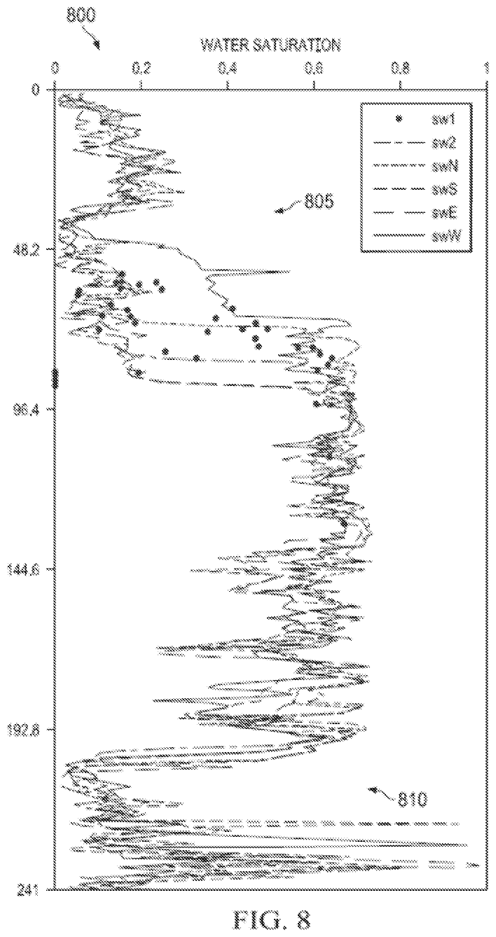

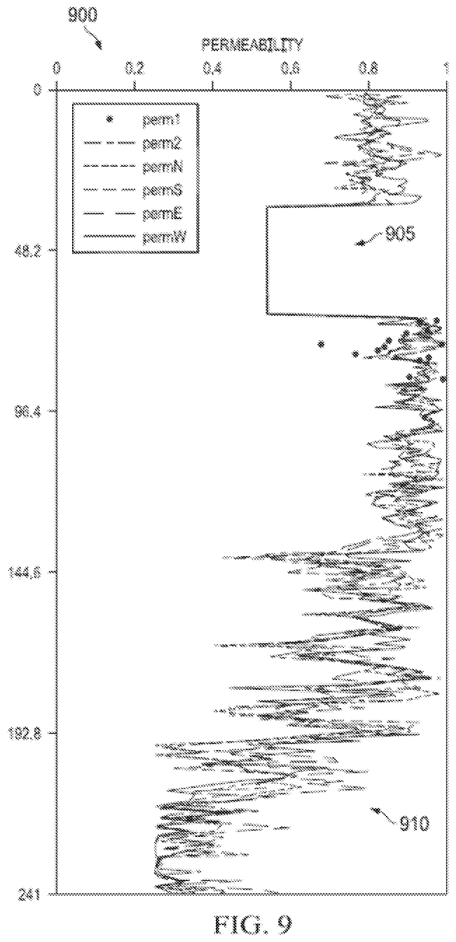

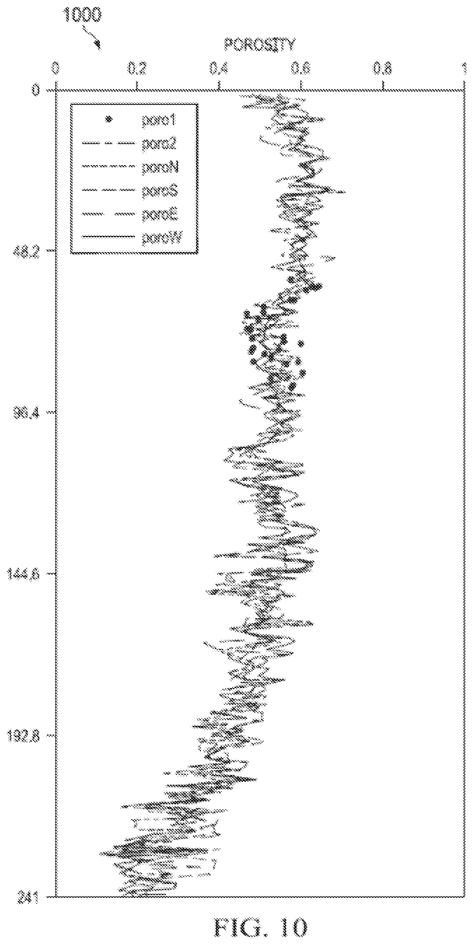

FIGS. 8-10 depict example parameters of the existing physical well and computer-simulated ancillary wells of FIG. 6, in accordance with various embodiments. Specifically, FIG. 8 depicts water saturation. The plot 800 of FIG. 8 is depicted with a k-index along the Y axis and increasing water saturation along the X axis (as oriented with respect to FIG. 8). FIG. 9 depicts permeability. The plot 900 of FIG. 9 depicts k-index along the Y axis and increasing permeability along the X axis. FIG. 10 depicts porosity. The plot 1000 of FIG. 10 depicts k-index along the Y axis and increasing porosity along the X axis.

Review of FIGS. 8-10 indicate two sidetrack opportunities may exist for the existing physical well. For example, the water saturation depicted in FIG. 8 depicts relatively low water saturation around approximately layers 1-48, and also around approximately layers 193-240. However, by considering the permeability profile depicted in FIG. 9, it may be seen that the permeability is better (e.g., higher) at the upper interval of approximately layers 1-48. Therefore, a sidetrack from the actual well at approximately layers 1-48 may be more advantageous than a deeper sidetrack. In comparing the water saturation, permeability, and porosity profiles, such a sidetrack well may be equally beneficial in any direction, as the profiles of each of the computer-simulated ancillary wells are relatively similar.

As noted, in some embodiments the sidetrack well may be a vertical sidetrack well rather than a horizontal sidetrack well. Such a vertical sidetrack well may be indicated if, for example, a computer-simulated ancillary well such as computer-simulated ancillary well 405 indicates a constant desirable parameter in a plot such as plot 500. Specifically, if the water saturation of computer-simulated ancillary well 405 was relatively low across a wide range of depths, then a vertical sidetrack well may be beneficial. Similarly, if the desirable parameter (e.g., water saturation) was relatively low for computer-simulated ancillary well 405 for a first range of depths, and then was also relatively low for a computer-simulated ancillary well such as computer-simulated ancillary well 425 for a second range of depths, then a graded sidetrack well may be beneficial that spans from the first to the second range of depths.

Based on the embodiments described above, one or more indications or parameters related to the sidetrack wells may be output. For example, the indications may include an indication of which existing physical well(s) may be candidates for a sidetrack well; the depth, direction, or grade of the sidetrack well; the timing of the sidetrack well (e.g., whether the trigger condition has occurred or is predicted to occur in the future), or some other parameter. Based on these indications, such a sidetrack well may be drilled, resources related to the sidetrack well may be acquired, further study may be performed, or some other action may be taken. In some embodiments, the indication may be output to a computer program for further display, processing, or analysis.

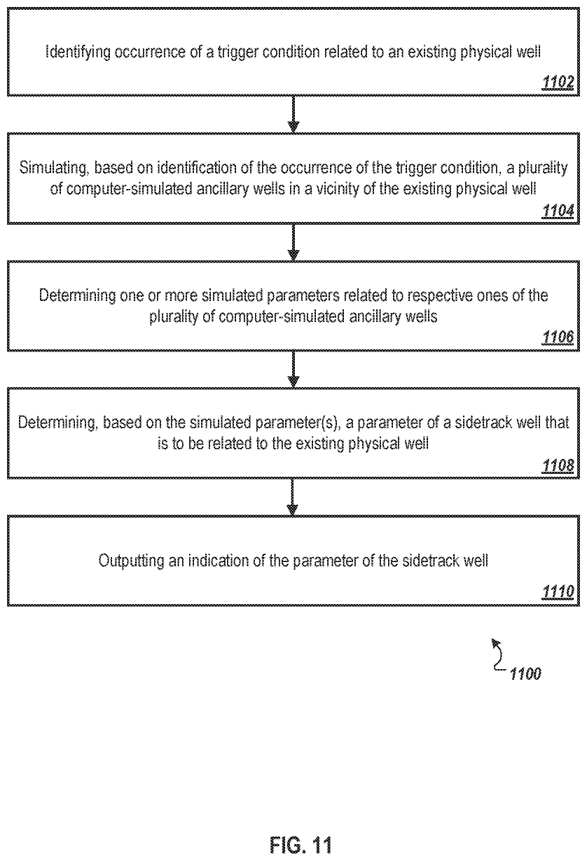

FIG. 11 depicts an example technique related to the identification of a parameter of a sidetrack well, in accordance with various embodiments. For clarity of presentation, the description that follows generally describes technique 1100 in the context of the other FIGS. in this description. However, it will be understood that technique 1100 can be performed, for example, by any suitable system, environment, software, and hardware, or a combination of systems, environments, software, and hardware, as appropriate. In some implementations, various elements of technique 1100 can be run in parallel, in combination, in loops, or in any order. In some embodiments, the entirety of the technique 1100 may be performed by a single electronic device or system (e.g., a single server, laptop, desktop machine, processor, etc.) In other embodiments the technique 1100 may be performed by a combination of such devices or systems (which may or may not be located in a single housing) such that one portion of the technique 1100 is performed by a first device or system and another portion of the technique 1100 is performed by a second device or system.

The technique 1100 may include identifying, at 1102 occurrence of a trigger condition related to an existing physical well. In some embodiments, the trigger condition may have already occurred, while in other embodiments the trigger condition may be a future occurrence of the trigger condition based on a simulation of the existing physical well. In some embodiments, the trigger condition may be related to a water-cut threshold of the existing physical well. In some embodiments, the trigger condition may be related to a GOR of the existing physical well.

The technique 1100 may further include simulating, at 1104 based on identification of the occurrence of the trigger condition, a plurality of computer-simulated ancillary wells in a vicinity of the existing physical well. In some embodiments, the simulation may include simulation of the formation of the computer-simulated ancillary wells, simulation of production of the computer-simulated ancillary wells, simulation of drilling of the computer-simulated ancillary wells, simulation of parameters of the rock at the location of the computer-simulated ancillary wells (e.g., porosity, permeability, or some other value), or some other type of simulation. The plurality of computer-simulated ancillary wells may include computer-simulated ancillary wells such as those discussed with respect to elements 305, 315, 320, 325, and 330. In some embodiments, a computer-simulated ancillary well of the plurality of computer-simulated ancillary wells (e.g., computer-simulated ancillary well 305) passes through a highest point of a perforation of the existing physical well (e.g., perforated section 310). In some embodiments, the plurality of computer-simulated ancillary wells include computer-simulated ancillary wells located in opposite lateral directions (e.g., North and South, East and West, or some other opposite lateral direction) from the existing physical well.

The technique 1100 may further include determining, at 1106, one or more simulated parameters related to respective ones of the plurality of computer-simulated ancillary wells. The simulated parameters may include, for example, porosity, permeability, water saturation, gas saturation, or some other parameter as described above.

The technique 1100 may further include determining, at 1108 based on the simulated parameter(s), a parameter of a sidetrack well that is to be related to the existing physical well. The parameter may be a starting depth of the sidetrack well (e.g., a depth at which the sidetrack well is coupled with the actual well), a direction of the sidetrack well, a grade of the sidetrack well, or some other parameter.

The technique 1100 may further include outputting, at 1110, an indication of the parameter of the sidetrack well. As described above, the outputting may include outputting an indication of the parameter to a user via a display, outputting the indication to another computer program for further processing or analysis, or some other type of output. In some embodiments, the indication may or may not be human-readable. In some embodiments, the indication may include a plurality of fields such as a field related to a name of the existing physical well and a field related to the parameter. In some embodiments, the indication may serve as a basis to drill a sidetrack well, acquire resources related to the sidetrack well, perform further study of the existing physical well or sidetrack well, or take some other action.

In some embodiments, the technique 1100 may further include facilitating, based on the indication of the parameter, drilling of the sidetrack well based on the parameter. For example, the electronic device may send one or more control signals to another electronic device (e.g., a wellbore drilling system) that is to cause the other electronic device to begin drilling of the sidetrack well as indicated by the parameter (e.g., in the indicated direction). In some embodiments, the facilitation may include outputting a human-readable indication or direction that is to provide information to the human to begin drilling of the sidetrack well. In some embodiments, the facilitation may include gathering the resources related to the drilling of the sidetrack well, or outputting an indication or direction to a human to begin such gathering.

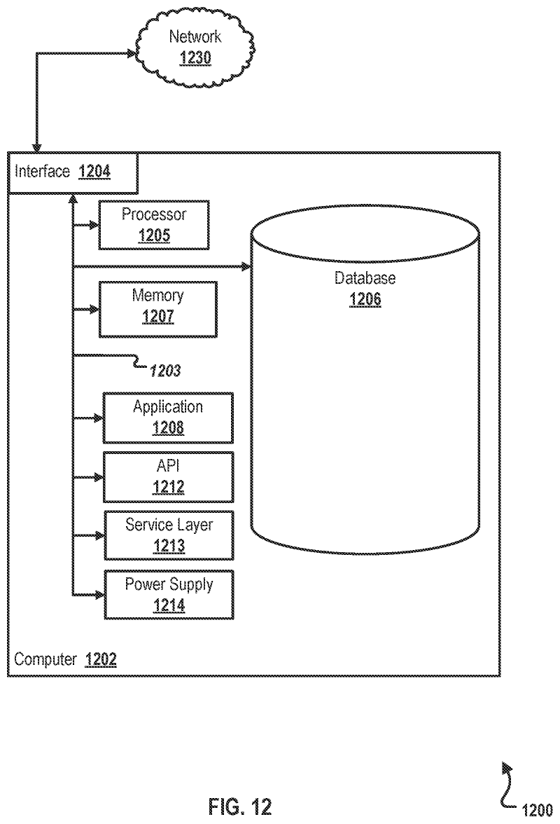

FIG. 12 is a block diagram of an example computer system 1200 (which may also be referred to as an electronic device or electronic system) that is used to provide computational functionalities associated with described algorithms, methods, functions, processes, flows, and procedures described in the present disclosure, according to some implementations of the present disclosure. The illustrated computer 1202 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1202 can include input devices such as keypads, keyboards, and touch screens that can accept user information. Also, the computer 1202 can include output devices that can convey information associated with the operation of the computer 1202. The information can include digital data, visual data, audio information, or a combination of information. The information can be presented in a graphical user interface (UI) (or GUI).

The computer 1202 can serve in a role as a client, a network component, a server, a database, a persistency, or components of a computer system for performing the subject matter described in the present disclosure. The illustrated computer 1202 is communicably coupled with a network 1230. In some implementations, one or more components of the computer 1202 can be configured to operate within different environments, including cloud-computing-based environments, local environments, global environments, and combinations of environments.

At a top level, the computer 1202 is an electronic computing device operable to receive, transmit, process, store, and manage data and information associated with the described subject matter. According to some implementations, the computer 1202 can also include, or be communicably coupled with, an application server, an email server, a web server, a caching server, a streaming data server, or a combination of servers.

The computer 1202 can receive requests over network 1230 from a client application (for example, executing on another computer 1202). The computer 1202 can respond to the received requests by processing the received requests using software applications. Requests can also be sent to the computer 1202 from internal users (for example, from a command console), external (or third) parties, automated applications, entities, individuals, systems, and computers.

Each of the components of the computer 1202 can communicate using a system bus 1203. In some implementations, any or all of the components of the computer 1202, including hardware or software components, can interface with each other or the interface 1204 (or a combination of both) over the system bus 1203. Interfaces can use an application programming interface (API) 1212, a service layer 1213, or a combination of the API 1212 and service layer 1213. The API 1212 can include specifications for routines, data structures, and object classes. The API 1212 can be either computer-language independent or dependent. The API 1212 can refer to a complete interface, a single function, or a set of APIs.

The service layer 1213 can provide software services to the computer 1202 and other components (whether illustrated or not) that are communicably coupled to the computer 1202. The functionality of the computer 1202 can be accessible for all service consumers using this service layer. Software services, such as those provided by the service layer 1213, can provide reusable, defined functionalities through a defined interface. For example, the interface can be software written in JAVA, C++, or a language providing data in extensible markup language (XML) format. While illustrated as an integrated component of the computer 1202, in alternative implementations, the API 1212 or the service layer 1213 can be stand-alone components in relation to other components of the computer 1202 and other components communicably coupled to the computer 1202. Moreover, any or all parts of the API 1212 or the service layer 1213 can be implemented as child or sub-modules of another software module, enterprise application, or hardware module without departing from the scope of the present disclosure.

The computer 1202 includes an interface 1204. Although illustrated as a single interface 1204 in FIG. 12, two or more interfaces 1204 can be used according to particular needs, desires, or particular implementations of the computer 1202 and the described functionality. The interface 1204 can be used by the computer 1202 for communicating with other systems that are connected to the network 1230 (whether illustrated or not) in a distributed environment. Generally, the interface 1204 can include, or be implemented using, logic encoded in software or hardware (or a combination of software and hardware) operable to communicate with the network 1230. More specifically, the interface 1204 can include software supporting one or more communication protocols associated with communications. As such, the network 1230 or the interface's hardware can be operable to communicate physical signals within and outside of the illustrated computer 1202.

The computer 1202 includes a processor 1205. Although illustrated as a single processor 1205 in FIG. 12, two or more processors 1205 can be used according to particular needs, desires, or particular implementations of the computer 1202 and the described functionality. Generally, the processor 1205 can execute instructions and can manipulate data to perform the operations of the computer 1202, including operations using algorithms, methods, functions, processes, flows, and procedures as described in the present disclosure.

The computer 1202 also includes a database 1206 that can hold data for the computer 1202 and other components connected to the network 1230 (whether illustrated or not). For example, database 1206 can be an in-memory, conventional, or a database storing data consistent with the present disclosure. In some implementations, database 1206 can be a combination of two or more different database types (for example, hybrid in-memory and conventional databases) according to particular needs, desires, or particular implementations of the computer 1202 and the described functionality. Although illustrated as a single database 1206 in FIG. 12, two or more databases (of the same, different, or combination of types) can be used according to particular needs, desires, or particular implementations of the computer 1202 and the described functionality. While database 1206 is illustrated as an internal component of the computer 1202, in alternative implementations, database 1206 can be external to the computer 1202.

The computer 1202 also includes a memory 1207 that can hold data for the computer 1202 or a combination of components connected to the network 1230 (whether illustrated or not). Memory 1207 can store any data consistent with the present disclosure. In some implementations, memory 1207 can be a combination of two or more different types of memory (for example, a combination of semiconductor and magnetic storage) according to particular needs, desires, or particular implementations of the computer 1202 and the described functionality. Although illustrated as a single memory 1207 in FIG. 12, two or more memories 1207 (of the same, different, or combination of types) can be used according to particular needs, desires, or particular implementations of the computer 1202 and the described functionality. While memory 1207 is illustrated as an internal component of the computer 1202, in alternative implementations, memory 1207 can be external to the computer 1202.

The application 1208 can be an algorithmic software engine providing functionality according to particular needs, desires, or particular implementations of the computer 1202 and the described functionality. For example, application 1208 can serve as one or more components, modules, or applications. Further, although illustrated as a single application 1208, the application 1208 can be implemented as multiple applications 1208 on the computer 1202. In addition, although illustrated as internal to the computer 1202, in alternative implementations, the application 1208 can be external to the computer 1202.

The computer 1202 can also include a power supply 1214. The power supply 1214 can include a rechargeable or non-rechargeable battery that can be configured to be either user- or non-user-replaceable. In some implementations, the power supply 1214 can include power-conversion and management circuits, including recharging, standby, and power management functionalities. In some implementations, the power supply 1214 can include a power plug to allow the computer 1202 to be plugged into a wall socket or a power source to, for example, power the computer 1202 or recharge a rechargeable battery.

There can be any number of computers 1202 associated with, or external to, a computer system containing computer 1202, with each computer 1202 communicating over network 1230. Further, the terms “client,” “user,” and other appropriate terminology can be used interchangeably, as appropriate, without departing from the scope of the present disclosure. Moreover, the present disclosure contemplates that many users can use one computer 1202 and one user can use multiple computers 1202.

Described implementations of the subject matter can include one or more features, alone or in combination.

For example, in a first implementation, a computer-implemented method includes identifying, by an electronic system, occurrence of a trigger condition related to an existing physical well; simulating, by the electronic system based on identification of the occurrence of the trigger condition, a plurality of computer-simulated ancillary wells in a vicinity of the existing physical well; determining, by the electronic system, one or more simulated parameters related to respective ones of the plurality of computer-simulated ancillary wells; determining, by the electronic system based on the one or more simulated parameters, a parameter of a sidetrack well that is to be related to the existing physical well; and outputting, by the electronic system, an indication of the parameter of the sidetrack well.

The foregoing and other described implementations can each, optionally, include one or more of the following features:

A first feature, combinable with any of the following features, wherein the method further includes facilitating, by the electronic system based on the indication of the parameter of the sidetrack well, drilling of the sidetrack well based on the parameter of the sidetrack well.

A second feature, combinable with any of the previous or following features, wherein the indication is a human-readable indication that includes a first field related to a name of the existing physical well and a second field related to the parameter of the sidetrack well.

A third feature, combinable with any of the previous or following features, wherein the trigger condition is related to a water-cut threshold of the existing physical well.

A fourth feature, combinable with any of the previous or following features, wherein the trigger condition is related to a gas-oil ratio of the existing physical well.

A fifth feature, combinable with any of the previous or following features, wherein the occurrence of the trigger condition is a future occurrence of the trigger condition based on a simulation of the existing physical well.

A sixth feature, combinable with any of the previous or following features, wherein a computer-simulated ancillary well of the plurality of computer-simulated ancillary wells passes through a highest point of a perforation of the existing physical well.

A seventh feature, combinable with any of the previous or following features, wherein the plurality of computer-simulated ancillary wells include computer-simulated ancillary wells located in opposite lateral directions from the existing physical well.

An eighth feature, combinable with any of the previous or following features, wherein the one or more simulated parameters are porosity, permeability, water saturation, or gas saturation of the computer-simulated ancillary wells.

A ninth feature, combinable with any of the previous or following features, wherein the parameter of the sidetrack well is a starting depth of the sidetrack well.

A tenth feature, combinable with any of the previous or following features, wherein the parameter of the sidetrack well is a direction of the sidetrack well.

An eleventh feature, combinable with any of the previous or following features, further including facilitating, by the electronic system, drilling of the sidetrack well in the direction.

A twelfth feature, combinable with any of the previous features, wherein the parameter of the sidetrack well is a grade of the sidetrack well.

In another implementation, one or more non-transitory computer-readable media include instructions that, upon execution of the instructions by one or more processors of an electronic system, are to cause the electronic system to: identify occurrence of a trigger condition related to an existing physical well; simulate, based on identification of the occurrence of the trigger condition, a plurality of computer-simulated ancillary wells in a vicinity of the existing physical well; determine one or more simulated parameters related to respective ones of the plurality of computer-simulated ancillary wells; determine, based on the one or more simulated parameters, a parameter of a sidetrack well that is to be related to the existing physical well; and output an indication of the parameter of the sidetrack well.

The foregoing and other described implementations can each, optionally, include one or more of the following features:

A first feature, combinable with any of the following features, wherein the instructions are further to facilitate, based on the indication of the parameter of the sidetrack well, drilling of the sidetrack well based on the parameter of the sidetrack well.

A second feature, combinable with any of the previous or following features, wherein the indication is a human-readable indication that includes a first field related to a name of the existing physical well and a second field related to the parameter of the sidetrack well.

A third feature, combinable with any of the previous or following features, wherein the trigger condition is related to a water-cut threshold of the existing physical well.

A fourth feature, combinable with any of the previous or following features, wherein the trigger condition is related to a gas-oil ratio of the existing physical well.

A fifth feature, combinable with any of the previous or following features, wherein the occurrence of the trigger condition is a future occurrence of the trigger condition based on a simulation of the existing physical well.

A sixth feature, combinable with any of the previous or following features, wherein a computer-simulated ancillary well of the plurality of computer-simulated ancillary wells passes through a highest point of a perforation of the existing physical well.

A seventh feature, combinable with any of the previous or following features, wherein the plurality of computer-simulated ancillary wells include computer-simulated ancillary wells located in opposite lateral directions from the existing physical well.

An eighth feature, combinable with any of the previous or following features, wherein the one or more simulated parameters are porosity, permeability, water saturation, or gas saturation of the computer-simulated ancillary wells.

A ninth feature, combinable with any of the previous or following features, wherein the parameter of the sidetrack well is a starting depth of the sidetrack well.

A tenth feature, combinable with any of the previous or following features, wherein the parameter of the sidetrack well is a direction of the sidetrack well.

An eleventh feature, combinable with any of the previous or following features, wherein the instructions are further to facilitate drilling of the sidetrack well in the direction.

A twelfth feature, combinable with any of the previous features, wherein the parameter of the sidetrack well is a grade of the sidetrack well.

In another implementation, an electronic system includes at least one processor; and one or more non-transitory computer-readable media that include instructions that, upon execution of the instructions by the one or more processors, are to cause the electronic system to: identify occurrence of a trigger condition related to an existing physical well; simulate, based on identification of the occurrence of the trigger condition, a plurality of computer-simulated ancillary wells in a vicinity of the existing physical well; determine one or more simulated parameters related to respective ones of the plurality of computer-simulated ancillary wells; determine, based on the one or more simulated parameters, a parameter of a sidetrack well that is to be related to the existing physical well; and output an indication of the parameter of the sidetrack well.

The foregoing and other described implementations can each, optionally, include one or more of the following features:

A first feature, combinable with any of the following features, wherein the instructions are further to facilitate, based on the indication of the parameter of the sidetrack well, drilling of the sidetrack well based on the parameter of the sidetrack well.

A second feature, combinable with any of the previous or following features, wherein the indication is a human-readable indication that includes a first field related to a name of the existing physical well and a second field related to the parameter of the sidetrack well.

A third feature, combinable with any of the previous or following features, wherein the trigger condition is related to a water-cut threshold of the existing physical well.

A fourth feature, combinable with any of the previous or following features, wherein the trigger condition is related to a gas-oil ratio of the existing physical well.

A fifth feature, combinable with any of the previous or following features, wherein the occurrence of the trigger condition is a future occurrence of the trigger condition based on a simulation of the existing physical well.

A sixth feature, combinable with any of the previous or following features, wherein a computer-simulated ancillary well of the plurality of computer-simulated ancillary wells passes through a highest point of a perforation of the existing physical well.

A seventh feature, combinable with any of the previous or following features, wherein the plurality of computer-simulated ancillary wells include computer-simulated ancillary wells located in opposite lateral directions from the existing physical well.

An eighth feature, combinable with any of the previous or following features, wherein the one or more simulated parameters are porosity, permeability, water saturation, or gas saturation of the computer-simulated ancillary wells.

A ninth feature, combinable with any of the previous or following features, wherein the parameter of the sidetrack well is a starting depth of the sidetrack well.

A tenth feature, combinable with any of the previous or following features, wherein the parameter of the sidetrack well is a direction of the sidetrack well.

An eleventh feature, combinable with any of the previous or following features, wherein the instructions are further to facilitate drilling of the sidetrack well in the direction.

A twelfth feature, combinable with any of the previous features, wherein the parameter of the sidetrack well is a grade of the sidetrack well.

In another implementation, an electronic system includes means to perform the method of the first implementation, optionally including one or more of its related features.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in-memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more GUIs and each of the displays of a particular GUI. Therefore, a GUI can represent any GUI, including, but not limited to, a web browser, a touch screen, or a command line interface (CLI) that processes information and efficiently presents the information results to the user. In general, a GUI can include a plurality of UI elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A method comprising:
identifying, by an electronic system, occurrence of a trigger condition related to an existing physical well;
simulating, by the electronic system based on identification of the occurrence of the trigger condition, a plurality of computer-simulated ancillary wells in a vicinity of the existing physical well;
determining, by the electronic system, one or more simulated parameters related to respective ones of the plurality of computer-simulated ancillary wells;
determining, by the electronic system based on the one or more simulated parameters, a parameter of a sidetrack well that is to be related to the existing physical well; and
outputting, by the electronic system, an indication of the parameter of the sidetrack well.

2. The method of claim 1, wherein the method further comprises facilitating, by the electronic system based on the indication of the parameter of the sidetrack well, drilling of the sidetrack well based on the parameter of the sidetrack well.

3. The method of claim 1, wherein the indication is a human-readable indication that includes a first field related to a name of the existing physical well and a second field related to the parameter of the sidetrack well.

4. The method of claim 1, wherein the trigger condition is related to a water-cut threshold of the existing physical well or a gas-oil ratio of the existing physical well.

5. The method of claim 1, wherein the occurrence of the trigger condition is a future occurrence of the trigger condition based on a simulation of the existing physical well.

6. The method of claim 1, wherein a computer-simulated ancillary well of the plurality of computer-simulated ancillary wells passes through a highest point of a perforation of the existing physical well.

7. The method of claim 1, wherein the plurality of computer-simulated ancillary wells include computer-simulated ancillary wells located in opposite lateral directions from the existing physical well.

8. The method of claim 1, wherein the one or more simulated parameters are porosity, permeability, water saturation, or gas saturation of the computer-simulated ancillary wells.

9. The method of claim 1, wherein the parameter of the sidetrack well is a starting depth of the sidetrack well, a direction of the sidetrack well, or a grade of the sidetrack well.

10. One or more non-transitory computer-readable media comprising instructions that, upon execution of the instructions by one or more processors of an electronic system, are to cause the electronic system to:
identify occurrence of a trigger condition related to an existing physical well;
simulate, based on identification of the occurrence of the trigger condition, a plurality of computer-simulated ancillary wells in a vicinity of the existing physical well;
determine one or more simulated parameters related to respective ones of the plurality of computer-simulated ancillary wells;
determine, based on the one or more simulated parameters, a parameter of a sidetrack well that is to be related to the existing physical well; and
output an indication of the parameter of the sidetrack well.

11. The one or more non-transitory computer-readable media of claim 10, wherein the trigger condition is related to a water-cut threshold of the existing physical well.

12. The one or more non-transitory computer-readable media of claim 10, wherein the trigger condition is related to a gas-oil ratio of the existing physical well.

13. The one or more non-transitory computer-readable media of claim 10, wherein the parameter of the sidetrack well is a starting depth of the sidetrack well.

14. The one or more non-transitory computer-readable media of claim 10, wherein the parameter of the sidetrack well is a direction of the sidetrack well.

15. The one or more non-transitory computer-readable media of claim 14, wherein the instructions are further to facilitate drilling of the sidetrack well in the direction.

16. The one or more non-transitory computer-readable media of claim 10, wherein the parameter of the sidetrack well is a grade of the sidetrack well.

17. An electronic system comprising:
one or more processors; and
one or more non-transitory computer-readable media comprising instructions that, upon execution of the instructions by the one or more processors, are to cause the electronic system to:
identify occurrence of a trigger condition related to an existing physical well;
simulate, based on identification of the occurrence of the trigger condition, a plurality of computer-simulated ancillary wells in a vicinity of the existing physical well;
determine one or more simulated parameters related to respective ones of the plurality of computer-simulated ancillary wells;
determine, based on the one or more simulated parameters, a parameter of a sidetrack well that is to be related to the existing physical well; and
output an indication of the parameter of the sidetrack well.

18. The electronic system of claim 17, wherein the occurrence of the trigger condition is a future occurrence of the trigger condition based on a simulation of the existing physical well.

19. The electronic system of claim 17, wherein a computer-simulated ancillary well of the plurality of computer-simulated ancillary wells passes through a highest point of a perforation of the existing physical well.

20. The electronic system of claim 17, wherein the plurality of computer-simulated ancillary wells include computer-simulated ancillary wells located in opposite lateral directions from the existing physical well.
